(19) United States
(12) Patent Application Publication
(10) Pub. No.: US 2003/0131009 A1
(43) Pub. Date: Jul. 10, 2003

(54) Transaction method and system

(75) Inventors: Leonard E. Frey, Endicott, NY (US); William M. Houston, Williston, VT (US); James A. Martin JR., Endicott, NY (US); Debra L. Zeggert, Binghamton, NY (US)

Correspondence Address: John R. Pivnichny, Ph.D, IBM Corporation, N50/040-4, 1701 North Street, Endicott, NY, 13760, US

(73) Assignee: International Business Machines Corporation, Armonk, NY (US)

(21) Appl. No.: 10/040,799

(22) Filed: Jan. 7, 2002

(51) Int. Cl. G06F 7/00

(52) U.S. Cl. 707/100

(57) ABSTRACT

Database transactions are performed involving multiple databases each having a processing agent. A transaction database is coupled to each of the multiple databases. A processing database agent writes a transaction document having a key and a detail to the transaction database. The processing agents periodically search the transaction database for a key and a detail to determine whether the agent should process the transaction. The agent then updates a record in its corresponding database based on the key and detail of the transaction. A wildcard character may be used in the key to indicate multiple documents in the respective processing database are affected by the transaction.

### TECHNICAL FIELD

The invention relates to a system and method of processing transactions in a plurality of interconnected databases and more particularly for providing an intermediary database having documents representing individual transactions to be processed by the databases.

### BACKGROUND OF THE INVENTION

Multiple databases are frequently employed for handling information having a differing scope. For example, a business may have multiple instances of a database defined by the physical location of a client. The business may also have multiple instances of a database where the scope of each instance is defined by the organizational division of a client and the computer assets of a client. All of the databases need to communicate with each other both for information look-up and information modification without conflict. That is, one database may need an information look-up in a second database while a third database needs to modify the same information in the second database.

Methods of updating or replicating other database structures have been developed. For example, in U.S. Pat. No. 5,408,619 Oran describes a technique for updating entries in a name service database from a plurality of client nodes. The client nodes and a plurality of name service databases are interconnected by a communication link. A client-server approach is used to receive a service request message from a client over the communication link. Update requests are transferred from one server node to other server nodes over the communication link.

Hoover et al., in U.S. Pat. No. 5,724,575 describe a system for retrieving data from remote databases on remotely located user computers. The user computers are interconnected with a object broker computer via a data communication network. A unique object identifier is assigned to data items of a particular subject. The data items of a particular subject are stored with the object identifier at a remote user computer. The location of the user computers and a mapping table of object identifiers are stored at the object broker computer. In response to a query to the object broker computer, the selected object identifier is retrieved and therefrom the location of one of the user computers having that object identifier and from the location retrieving data stored in the user computer at that location.

Brodersen et al. in U.S. Pat. No. 6,092,083 describe a database system having an enterprise server, at least one docking client, and at least one workgroup user client. A transaction is created in a database resident on a workgroup user client. The transaction is entered into a transaction log on the user client and a transaction file is created in an outbox of the user client. The transaction file is then copied to an agency database on the docking client. The agency database also has a transaction log. This transaction log is then read and data files corresponding to transactions not originating at the enterprise server are copied to an inbox on the enterprise server. Transactions are then updated into an enterprise database on the enterprise server.

U.S. Pat. Nos. 5,408,619 and 6,092,083 are incorporated herein by reference in their entirety.

Understandably none of the aforementioned methods address the server to server, any to any, database to database transaction requirements stated above. In accordance with the teachings of the present invention, there is defined a new method and system for allowing enhanced operational capabilities in such a database to database transaction structure.

It is believed that such a capability would constitute a significant advancement in the art.

### OBJECTS AND SUMMARY OF THE INVENTION

It is therefore a principal object of the present invention to enhance the database transaction art by providing a method with enhanced capabilities.

It is another object to provide a system with enhanced capabilities for processing transactions by a plurality of databases.

It is yet another object to provide a computer program product for instructing a processor to handle database transactions in an enhanced manner.

These and other objects are attained in accordance with one embodiment of the invention wherein there is provided a method of processing transactions, comprising the steps of, providing a plurality of processing databases each having a respective agent, providing a transaction database, writing one or more transactions, each having a key and a detail, from a first of the plurality of processing databases to the transaction database, periodically searching, using a processing agent from a second of the plurality of processing databases, in the transaction database for a key and detail to determine whether the processing agent should process the one or more transactions, and updating a record in the second of the plurality of processing databases, by using the key and detail.

In accordance with another embodiment of the invention there is provided a system for processing transactions, comprising, a plurality of processing databases each having a respective agent, a transaction database, means for periodically searching, using a processing agent from a second of the plurality of processing databases, in the transaction database for a key and detail to determine whether the processing agent should process the one or more transactions, and means for updating a record in the second of the plurality of processing databases, by using the key and detail.

In accordance with yet another embodiment of the present invention there is provided a computer program product for instructing a computer processor to handle transactions, the computer program product comprising, a computer readable medium, first program instruction means for providing a plurality of processing databases each having a respective agent, second program instruction means for providing a transaction database, third program instruction means for writing one or more transactions, each having a key and a detail, from a first of the plurality of processing databases to the transaction database, fourth program instruction means for periodically searching, using a processing agent from a second of the plurality of processing databases, in the transaction database for a key and detail to determine whether the processing agent should process the one or more transactions, and fifth program instruction means for updating a record in the second of the plurality of processing databases, by using the key and detail, and wherein all the program instruction means are recorded on the medium.

### BRIEF DESCRIPTION OF THE DRAWINGS

FIG. 1 shows the database elements of one embodiment of the present invention;

FIG. 2 is a flowchart of the steps of a database management process in accordance with the present invention;

FIG. 3 is a screen capture of a report of transactions; and

FIG. 4 is a screen capture of a report of a single transaction.

### BEST MODE FOR CARRYING OUT THE INVENTION

For a better understanding of the present invention, together with other and further objects, advantages and capabilities thereof, reference is made to the following disclosure and the appended claims in connection with the above-described drawings.

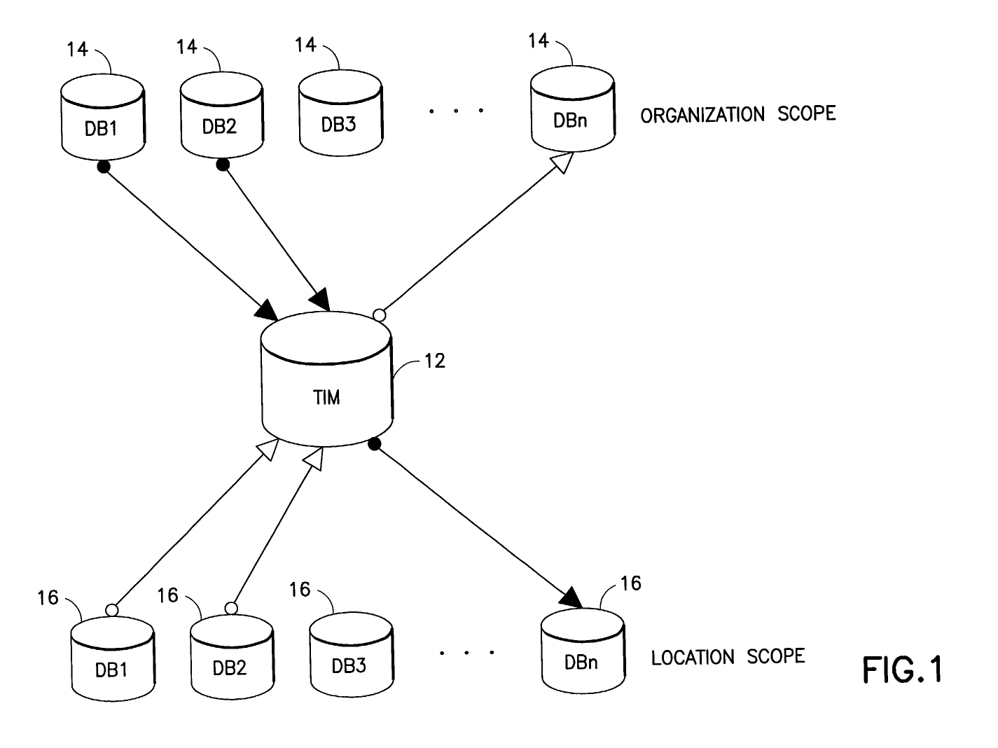

In FIG. 1 there is shown a structure of databases in accordance with the present invention. Shown are n databases 14 each having an organization scope. The databases may each be any type of database including but not limited to a relational database such as a DB2® (DB2 is a registered trademark of IBM Corporation) database or ORACLE database, a messaging database, a sequential database, a spreadsheet database, or a LOTUS NOTES® (LOTUS NOTES is a registered trademark of Lotus Development Corporation) database. A database having an organization scope is a database having a set of documents in which the documents are defined by a company organization such as by division or by department.

Database 14 may reside on one or more servers which may be positioned at any geographical location.

FIG. 1 also shows another n databases 16 of any type each having a location scope. It is not necessary that the number of databases 14 and 16 be equal. Databases 16 have a scope different from the scope of databases 14. In FIG. 1 databases 16 have a location scope which shall be taken herein to mean having a set of documents in which the documents are defined by a location within the company such as by site, or by building. Databases having any differing scopes may be used at 14 and 16 respectively with the organization and location scopes of FIG. 1 serving as an example of differing scopes.

A transaction database 12, referred to as a transaction information manager (TIM) is provided. TIM may also be any type of database.

Each of the databases 14 and 16 includes a respective agent for processing transactions involving data within the respective database. These 14 and 16 are therefore referred to as processing databases. Each processing database is interconnected to transaction database 12 for the purpose of writing e.g. sending, or reading e.g. receiving, a transaction document. In the case where transaction database 12 is a LOTUS NOTES database, then the agents will need to be adapted to read a LOTUS NOTES database. Any type of interconnection may be used and will necessarily depend on the physical location of transaction database 12 and each processing database 14, 16 as well as other factors including but not limited to the transaction rate, database type, and physical hardware used to implement 12, 14, 16 as is well known in the art.

Within transaction database 12 are documents each representing an individual transaction. The transactions each have a key and a detail. The key specifies which document in a processing database is affected by a transaction. The key may also include a wildcard character, such as * (asterisk) to designate several similarly named documents are affected. The detail specifies what action to take with the document specified by the key. Any type of action may be performed by the respective agent on the document based on the content of the detail. For example with an update action, data within the document may be replaced with data from the detail. The transaction may also include a processor designation specifying which processing database is affected by that particular transaction. A status flag may also be set in one or more transactions. For example the status flag may be set to a status of created, processed, or failed by an agent. Other status settings known in the art may also be used.

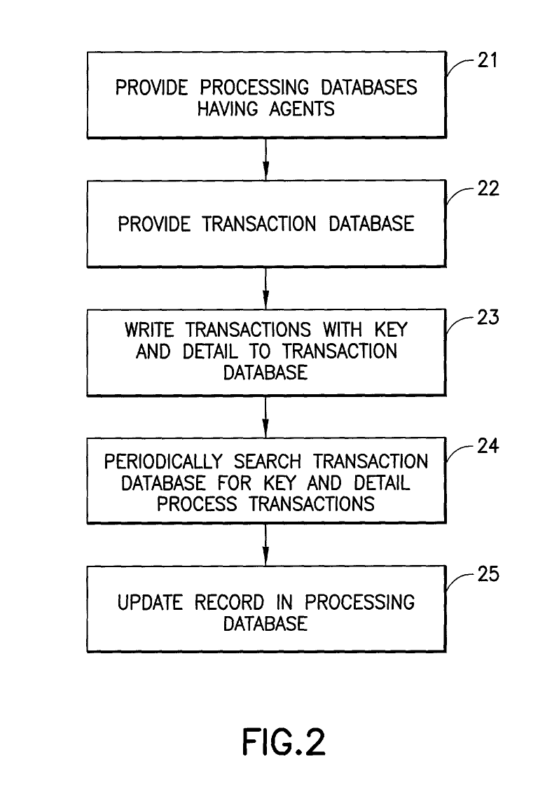

In FIG. 2 there is shown a flowchart of the operation of the present invention. In step 21 a plurality of processing databases each having a respective agent are provided as described above. A transaction database is provided in step 22. In step 23, one or more transaction documents, each having a key and a detail are written from one of the processing databases to the transaction database. In step 24, the agent of a second processing database periodically searches the transaction database 12 for a key and a detail to determine whether it should process one or more of the transactions residing there. In step 25, the agent of the second processing database updates a record processing database based on a key and detail located in step 24. Prior to performing an action, the agent may transfer the transaction document from transaction database 12 to its respective processing database.

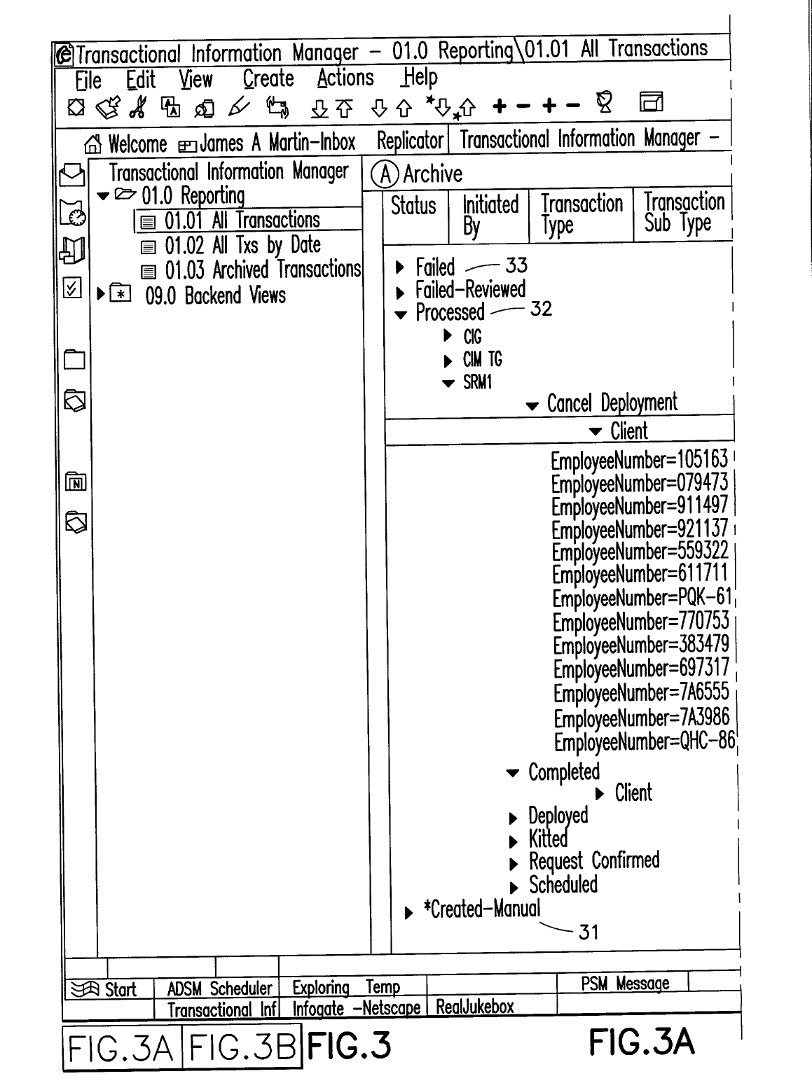

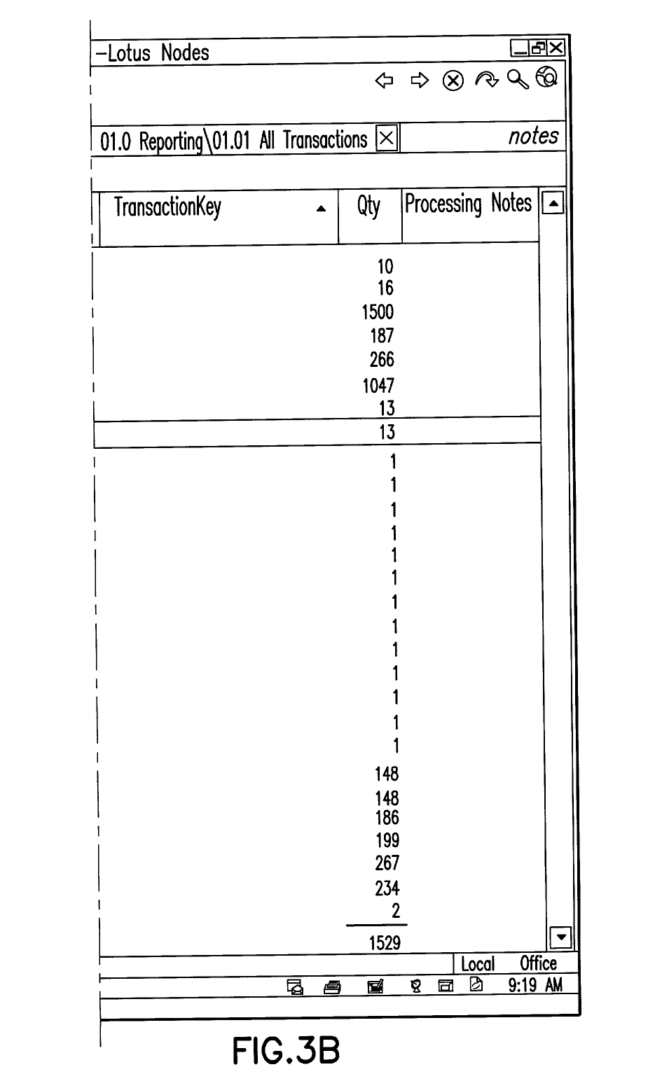

In FIG. 3 there is shown a screen capture of a report of transactions from a transaction information manager. The transactions are listed by the status flags of created 31, processed 32, and failed 33. Further detail is shown for the 1500 transactions having a status flag of processed.

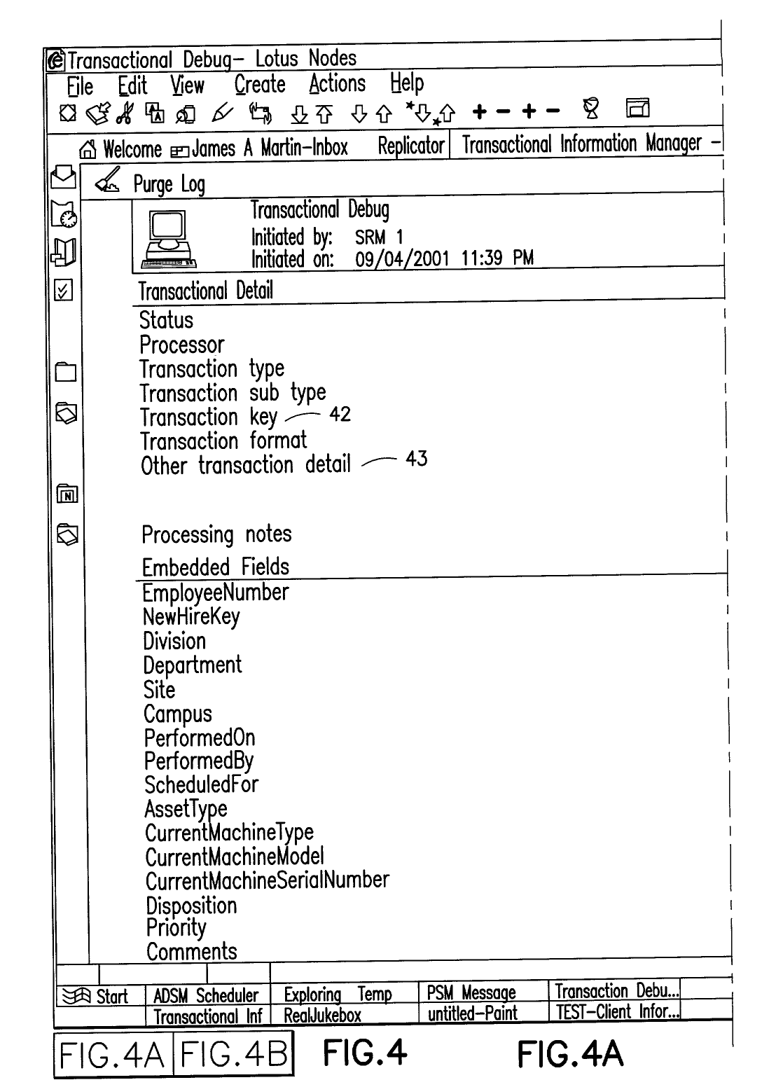

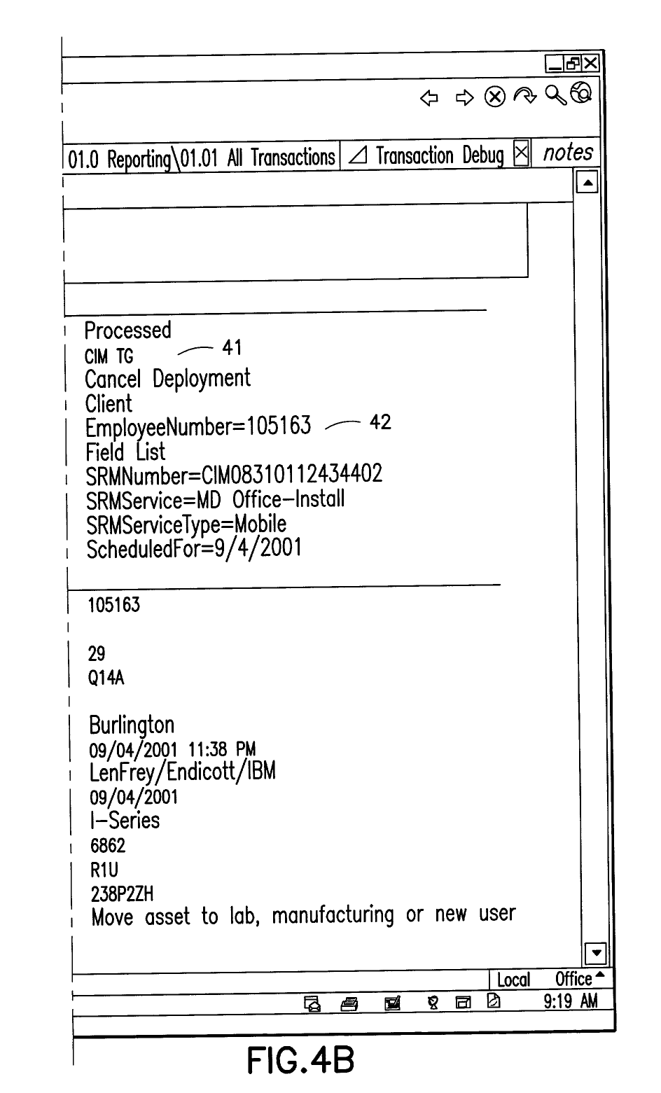

In FIG. 4 there is shown a screen capture of a report of a single transaction. The agent 41 which processed the transaction is shown along with the key 42 and detail 43.

While there have been shown and described what are at present considered the preferred embodiments of the invention, it will be obvious to those skilled in the art that various changes and modifications may be made therein without departing from the scope of the invention as defined by the appended claims.

What is claimed is:

1. A method of processing transactions, comprising the steps of:
providing a plurality of processing databases each having a respective agent;
providing a transaction database;
writing one or more transactions, each having a key and a detail, from a first of said plurality of processing databases to said transaction database;
periodically searching, using a processing agent from a second of said plurality of processing databases, in said transaction database for a key and detail to determine whether said processing agent should process said one or more transactions; and
updating a record in said second of said plurality of processing databases, by using said key and detail.

2. The method of claim 1, wherein said transaction database is a messaging database.

3. The method of claim 1, wherein said transaction database is a LOTUS NOTES database and said plurality of processing databases are adapted to read said LOTUS NOTES database.

4. The method of claim 1, wherein each of said one or more transactions has a processor designation specifying which of said plurality of processing databases is affected by said each of said one or more transactions.

5. The method of claim 1, wherein said key includes a wildcard character.

6. The method of claim 1, further comprising the step of transferring said one or more transactions from said transaction database to said second of said plurality of processing databases prior to said step of updating a record.

7. The method of claim 1, further comprising the step of setting a status flag in said one or more transactions.

8. A system for processing transactions, comprising:
a plurality of processing databases each having a respective agent;
a transaction database;
means for periodically searching, using a processing agent from a second of said plurality of processing databases, in said transaction database for a key and detail to determine whether said processing agent should process said one or more transactions; and
means for updating a record in said second of said plurality of processing databases, by using said key and detail.

9. The system of claim 8, wherein said transaction database is a messaging database.

10. The system of claim 8, wherein said transaction database is a LOTUS NOTES database and said plurality of processing databases are adapted to read said LOTUS NOTES database.

11. The system of claim 8, wherein each of said one or more transactions has a processor designation specifying which of said plurality of processing databases is affected by said each of said one or more transactions.

12. The system of claim 8, wherein said key includes a wildcard character.

13. The system of claim 8, further comprising means for transferring said one or more transactions from said transaction database to said second of said plurality of processing databases.

14. The system of claim 8, wherein said one or more transactions have a status flag.

15. A computer program product for instructing a computer processor to handle transactions, said computer program product comprising:
a computer readable medium;
first program instruction means for providing a plurality of processing databases each having a respective agent;
second program instruction means for providing a transaction database;
third program instruction means for writing one or more transactions, each having a key and a detail, from a first of said plurality of processing databases to said transaction database;
fourth program instruction means for periodically searching, using a processing agent from a second of said plurality of processing databases, in said transaction database for a key and detail to determine whether said processing agent should process said one or more transactions; and
fifth program instruction means for updating a record in said second of said plurality of processing databases, by using said key and detail; and wherein
all said program instruction means are recorded on said medium.

16. The computer program product of claim 15, wherein each of said one or more transactions has a processor designation specifying which of said plurality of processing databases is affected by said each of said one or more transactions.

17. The computer program product of claim 15, wherein said key includes a wildcard character.

18. The computer program product of claim 15, further comprising sixth program instruction means for transferring said one or more transactions from said transaction database to said second of said plurality of processing databases.

19. The computer program method of claim 15, further comprising sixth program instruction means for setting a status flag in said one or more transactions.
